(19) United States
(12) Patent Application Publication
(10) Pub. No.: US 2003/0086643 A1
(43) Pub. Date: May 8, 2003

(54) Wavelength division multiplexer and wavelength dividing method

(76) Inventors: Huang-Kun Chen, Tao Yuan (TW); Shih-Chien Chang, Taipei (TW)

Correspondence Address: MARTINE & PENILLA, LLP, 710 LAKEWAY DRIVE, SUITE 170, SUNNYVALE, CA, 94085, US

(21) Appl. No.: 10/139,097

(22) Filed: May 3, 2002

(30) Foreign Application Priority Data
Nov. 8, 2001 (TW) 90127807

(51) Int. Cl. G02B 6/293; G02B 6/26

(52) U.S. Cl. 385/24; 385/31

(57) ABSTRACT

Disclosed is a wavelength division multiplexer (WDM) and its wavelength dividing method. The WDM includes an optical input end, a first optical output end, a second optical output end, a collimator, a filter and a reflective device. The optical input end receives multi-wavelength optical signals. The filter transmits a first-wavelength optical signal of the multi-wavelength optical signals and reflects a second-wavelength optical signal of the multi-wavelength optical signals to the second optical output end. The first-wavelength optical signal is again reflected by the reflective device and transmitted through the filter toward the first optical output end. The collimator collimates the multi-wavelength optical signals, the first-wavelength optical signal and the second-wavelength optical signal.

### FIELD OF THE INVENTION

The invention relates to a wavelength division multiplexer and a wavelength dividing method, and more particularly to a wavelength division multiplexer and a wavelength dividing method using a filter and a reflective device.

### DESCRIPTION OF THE RELATED ART

In recent years, with the quick development of the Internet, the data transfer throughput over the Internet has increased greatly. As a result, the transfer speed over the Internet cannot meet the requirements of the users. Consequently, the technology for transferring digital data has moved from the conventional twist-pair copper wires to optic fibers. Compared with a conventional twist-pair copper wire used to transfer electrical signals, the optic fiber has a number of advantages such as a large capacity, small signal loss, free from electromagnetic interference, cheap material, light weight and small volume.

In the early days of information transmission using an optic fiber, light with a specific wavelength represented a piece of information. However, only a beam of light can travel in the fiber at one time. Thus, the bandwidth provided by the fiber is not sufficient. New concepts of wavelength combination and wavelength division, in which several light beams representing plural pieces of information can travel in the fiber at the same time, arise due to this requirement. In this case, the bandwidth of the optic fiber greatly increases to several times the bandwidth of the earlier information transmissions. Currently, the optical passive component that is usually used for wavelength division is a wavelength division multiplexer (WDM). The WDM is capable of increasing the useful bandwidth by transferring laser light with different wavelengths in a single fiber. For example, the originally useful bandwidth increases to four times thereof by using light with four wavelengths to carry signals. The wavelength division multiplexers are classified as Bulk Grating (BG) Wavelength Division Multiplexers, Filter Wavelength Division Multiplexers, Fiber Bragg Grating (FBG) Wavelength Division Multiplexers, Planar Lightwave Circuit (PLC) Wavelength Division Multiplexers, and the like.

The wavelength spacing in a dense wavelength division multiplexer (DWDM) is between 0.4 nm and 3.2 nm. Since the channel spacing of the wavelength division multiplexer is small, it is convenient to spread out the bandwidth. For example, eight OC-48 systems can be carried in an optic fiber by using the technology of the wavelength division multiplexer, thereby increasing the total transmission speed from the original bandwidth of 2.5 Gbps of the OC-48 system to eight times (that is, 20 Gbps).

For example, a symmetrical system is used as the channel architecture in a conventional wavelength division multiplexer. As shown in FIG. 1, a wavelength division multiplexer 1 includes a filter 11, a first lens 12, a second lens 13, a dual-fiber module 14 and a single-fiber module 15. Both of the first lens 12 and the second lens 13 are symmetrically arranged at both sides of the filter 11, respectively. The dual-fiber module 14 is located at the left-hand side of the first lens 12. The single-fiber module 15 is located at the right-hand side of the second lens 13. As stated above, the filter 11 is a narrow band filter, and the first lens 12 and the second lens 13 are graduated refractive index lenses (GRIN lenses). The dual-fiber module 14 includes a first fiber 141 and a second fiber 142. The first fiber 141 serves as an input end of multi-wavelength optical signals 60. The second fiber 142 serves as a first output end. The single-fiber module 15 includes a third fiber 151 serving as a second output end.

In the wavelength division multiplexer 1, the multi-wavelength optical signals 60 incident on the first lens 12 via the first fiber 141, and then the first lens 12 collimates the multi-wavelength optical signals 60 toward the filter 11. The filter 11 transmits a first-wavelength optical signal 61 of the multi-wavelength optical signals 60, and reflects a second-wavelength optical signal 62 of the multi-wavelength optical signals 60. Therefore, the first-wavelength optical signal 61 is collimated and incident on the third fiber 151 (second output end) via the second lens 13. On the other hand, the second-wavelength optical signal 62 is collimated and incident on the second fiber 142 (first output end) via the first lens 12.

As stated above, the wavelength division multiplexer 1 includes two GRIN lenses. However, such GRIN lenses are very expensive. Therefore, it is an important subject matter of the invention to decrease the number of such lenses so as to reduce the manufacturing costs and the degrees of freedom for adjustment during the assembling processes of the wavelength division multiplexer.

### SUMMARY OF THE INVENTION

In view of the above-mentioned problems, it is therefore an important object of the invention to provide a wavelength division multiplexer using only one collimator so that the manufacturing costs of the wavelength division multiplexer can be reduced. In addition, the degrees of freedom for adjustment during the assembling processes of the wavelength division multiplexer can be reduced, thereby facilitating the automatic mass production of the wavelength division multiplexer.

To achieve the above-mentioned object, a wavelength division multiplexer in accordance with the invention includes an optical input end, a first optical output end, a second optical output end, a collimator, a filter and a reflective device. In this invention, multi-wavelength optical signals incident on the filter from the optical input end. Then, the filter transmits a first-wavelength optical signal of the multi-wavelength optical signals. The filter also reflects the optical signals with other wavelengths toward the second optical output end. After the first-wavelength optical signal is transmitted through the filter, it is reflected back to the filter by the reflective device. Then, the first-wavelength optical signal is transmitted through the filter and toward the first optical output end. The collimator collimates the multi-wavelength optical signals, the first-wavelength optical signal and the second-wavelength optical signal. In the invention, the collimator provided between each of the optical input and output ends and the filter collimates the multi-wavelength optical signals toward the filter, the first-wavelength optical signal toward the first optical output end, and the second-wavelength optical signal toward the second optical output end.

The invention also provides a wavelength dividing method including the following steps. First, multi-wavelength optical signals are input. Then, a first-wavelength optical signal of the multi-wavelength optical signals is transmitted toward a reflective device. The optical signals with other wavelengths are reflected to a second optical output end. Finally, the first-wavelength optical signal is reflected to a first optical output end.

As stated above, the invention can separate the required wavelengths using the combination of optical components including a plurality of optical input and output ends, a collimator, a filter, a mirror, and the like. In other words, the invention only uses a collimator so that the manufacturing costs of the wavelength division multiplexer can be reduced. In addition, the degrees of freedom for adjustment during the assembling processes of the wavelength division multiplexer can be reduced, thereby facilitating the automatic mass production of the wavelength division multiplexer.

### BRIEF DESCRIPTION OF THE DRAWINGS

FIG. 1 is a schematic illustration showing a conventional wavelength division multiplexer.

FIG. 2 is a schematic illustration showing a wavelength division multiplexer in accordance with a preferred embodiment of the invention.

FIG. 3 is a schematic illustration showing a combination of wavelength division multiplexers in accordance with the preferred embodiment of the invention.

FIG. 4 is a flow chart showing a wavelength dividing method in accordance with the preferred embodiment of the invention.

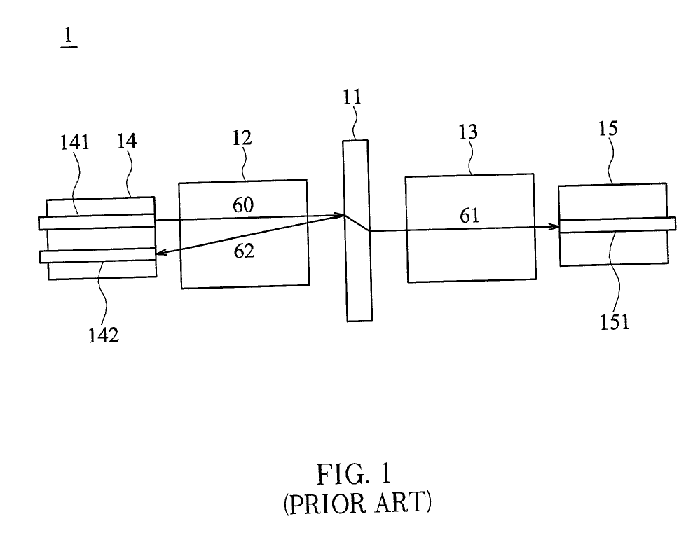

### DETAILED DESCRIPTION OF THE PREFERRED EMBODIMENT

The wavelength division multiplexer in accordance with a preferred embodiment of the invention will be described with reference to the accompanying drawings, wherein the same reference numbers denote the same elements.

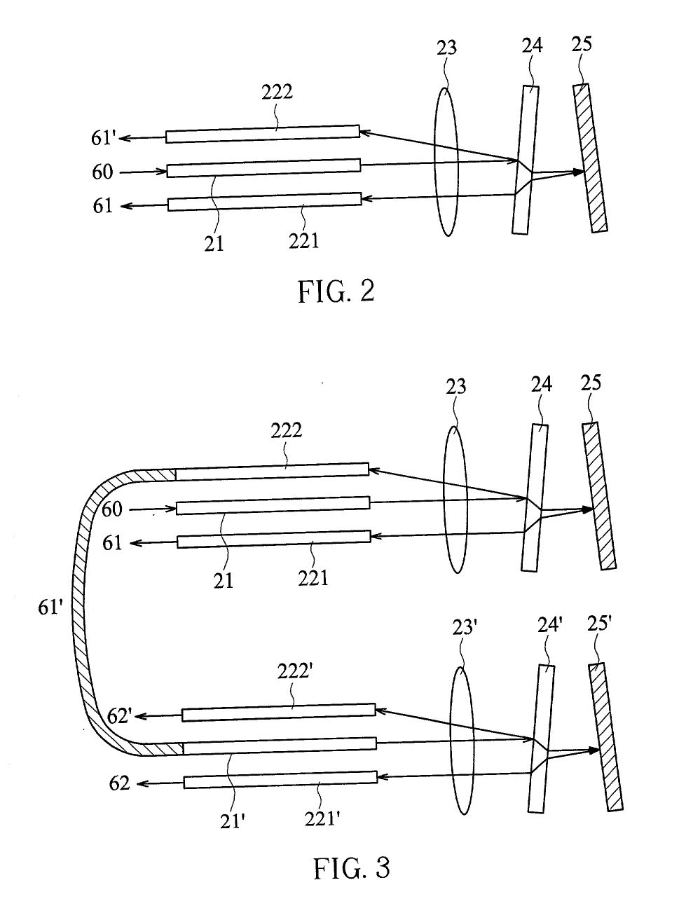

Referring to FIG. 2, a wavelength division multiplexer in accordance with a preferred embodiment of the invention includes an optical input end 21, a first optical output end 221, a second optical output end 222, a collimator 23, a filter 24 and a reflective device 25.

In this embodiment, the optical input end 21, the first optical output end 221 and the second optical output end 222 may be fibers, respectively, so as to keep the intensity of the optical signal after the optical signal travels a long distance.

The collimator 23 may be any type of lens (such as an aspheric lens or an arbitrary collimator) having a collimating function for focusing the optical signal transmitted through the collimator 23 to be incident on a predetermined position, for example, the first optical output end 221, the second optical output end 222 or the like.

The filter 24 may be a narrow band filter composed of plural (several tens to several hundreds) dielectric layers made of silicon dioxide (SiO₂), titanium dioxide (TiO₂), or the like. The narrow band filter only transmits optical signals with a specific wavelength from the multi-wavelength optical signals and reflects optical signals with other wavelengths.

The reflective device 25 may be a mirror.

As stated above, the multi-wavelength optical signals 60 including the optical signals having wavelengths of λ₁ to λₙ are input from the optical input end 21. Then, the multi-wavelength optical signals 60 pass through the collimator 23, which collimates the multi-wavelength optical signals 60 toward the filter 24. The filter 24 transmits the first-wavelength optical signal 61 having the wavelength of λ₁ and reflects the multi-wavelength optical signals 61′ having wavelengths of λ₂ to λₙ to the collimator 23. The first-wavelength optical signal 61 is incident on the reflective device 25 and then reflected to the filter 24 by the reflective device 25. Again, the filter 24 transmits the first-wavelength optical signal 61 to the collimator 23. Then, the collimator 23 collimates the multi-wavelength optical signals 61′ having wavelengths of λ₂ to λₙ toward the second optical output end 222, and collimates the first-wavelength optical signal 61 toward the first optical output end 221.

In this embodiment, a non-zero incident angle is formed between the multi-wavelength optical signals 60 and the filter 24. That is, the incident direction of the multi-wavelength optical signals 60 to the filter 24 is not perpendicular to the axial direction of the filter 24. Accordingly, the travelling direction of the reflected multi-wavelength optical signals 61′ is not directed to the incident direction of the multi-wavelength optical signals 60. Instead, the reflected multi-wavelength optical signals 61′ are incident to the second optical output end 222 after the collimating process of the collimator 23. In other words, the multi-wavelength optical signals 61′ can be reflected and focused on the second optical output end 222 by inclining the filter 24 to a specific angle. Similarly, since a non-zero incident angle is also formed between the reflective device 25 and the multi-wavelength optical signals 60, the travelling direction of the reflected first-wavelength optical signal 61 is not directed to the originally travelling direction thereof. Instead, the reflected first-wavelength optical signal 61 is incident to the first optical output end 221 after the collimating process of the collimator 23. That is, the first-wavelength optical signal 61 is completely reflected to the first optical output end 221 by inclining the reflective device 25 to a specific angle.

In another embodiment of the invention, the multi-wavelength optical signals 61′ having wavelengths of λ₂ to λₙ further incident on another wavelength division multiplexer. As shown in FIG. 3, the multi-wavelength optical signals 61′ incident to the second optical input end 21′. As stated above, after the collimating process of the collimator 23′, the filtering process of the filter 24′ and the reflecting process of the reflective device 25′, the second-wavelength optical signal 62 having a wavelength of λ₂ is collimated and incident to the third optical output end 221′, the multi-wavelength optical signals 62′ having wavelength of λ₃ to λₙ are collimated and incident on the fourth optical output end 222′. Similarly, by using n-pieces of wavelength division multiplexers of this embodiment, it is possible to assemble a dense wavelength division multiplexer capable of outputting each wavelength (λ₁ to λₙ) of the multi-wavelength optical signals 60, respectively.

To provide a better understanding of the invention, an example is made for describing the flow of the wavelength dividing method in accordance with the preferred embodiment of the invention.

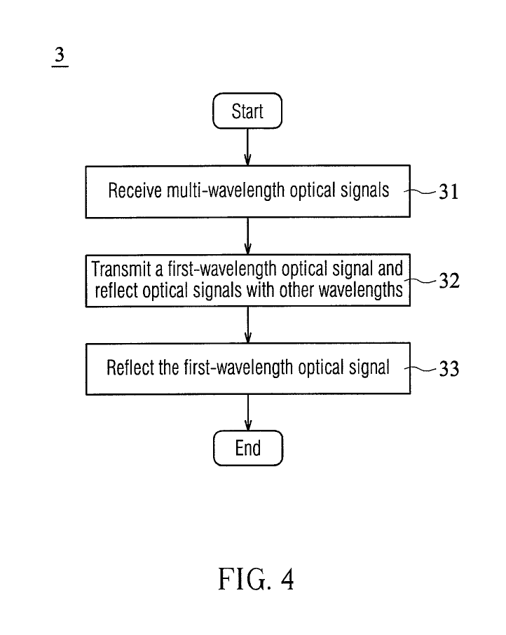

Referring to FIG. 4, in the wavelength dividing method 3 of the preferred embodiment of the invention, multi-wavelength optical signals, such as the multi-wavelength optical signals 60 having wavelengths of λ₁ to λₙ, are received in step 31.

Then, in step 32, a first-wavelength optical signal is transmitted and the optical signals with other wavelengths are reflected so that the first-wavelength optical signal can be separated from the multi-wavelength optical signals. In this embodiment, transmitting the first-wavelength optical signal and reflecting the optical signals with other wavelengths can achieve the separation of the first-wavelength optical signal. For example, a specific narrow band filter is used for transmitting the first-wavelength optical signal 61 with wavelength of λ₁ and for reflecting the multi-wavelength optical signals 61′ with wavelengths of λ₂ to λₙ.

Finally, in step 33, the first-wavelength optical signal is reflected. The first-wavelength optical signal 61 can be incident to the first optical output end 221 after the collimating process of the collimator 23. Also, the multi-wavelength optical signals 61′ with wavelengths of λ₂ to λₙ can be incident to the second optical output end 222.

To sum up, only one collimator is used in this invention. Thus, the manufacturing costs of the wavelength division multiplexer can be reduced. In addition, the degrees of freedom for adjustment during the assembling processes of the wavelength division multiplexer can be reduced, thereby facilitating the automatic mass production of the wavelength division multiplexer.

While the invention has been described by way of an example and in terms of a preferred embodiment, it is to be understood that the invention is not limited to the disclosed embodiment. To the contrary, it is intended to cover various modifications. For instance, the filter may be a high-pass filter or a low-pass filter. Therefore, the scope of the appended claims should be accorded the broadest interpretation, so as to encompass all such modifications.

What is claimed is:

1. A wavelength division multiplexer comprising:
an optical input end for receiving multi-wavelength optical signals;
a first optical output end;
a second optical output end;
a filter for reflecting a second-wavelength optical signal of the multi-wavelength optical signals into the second optical output end and for transmitting a first-wavelength optical signal of the multi-wavelength optical signals;
a reflective device for reflecting the first-wavelength optical signal, which passes through the filter and to be incident to the first optical output end; and
a collimating device for collimating the multi-wavelength optical signals, the first-wavelength optical signal and the second-wavelength optical signal.

2. The wavelength division multiplexer according to claim 1, wherein the collimating device is a lens or a collimator.

3. The wavelength division multiplexer according to claim 1, wherein the filter is a narrow band filter.

4. The wavelength division multiplexer according to claim 1, wherein the reflective device is a mirror.

5. A wavelength division multiplexer comprising:
an optical input end for receiving multi-wavelength optical signals;
a first optical output end;
a second optical output end;
a filter for reflecting a second-wavelength optical signal of the multi-wavelength optical signals into the second optical output end and for transmitting a first-wavelength optical signal of the multi-wavelength optical signals; and
a reflective device for reflecting the first-wavelength optical signal, which passes through the filter and to be incident to the first optical output end.

6. The wavelength division multiplexer according to claim 5, further comprising:
a collimating device for collimating the multi-wavelength optical signals, the first-wavelength optical signal and the second-wavelength optical signal.

7. The wavelength division multiplexer according to claim 6, wherein the collimating device is a lens or a collimator.

8. The wavelength division multiplexer according to claim 6, wherein the filter is a narrow band filter.

9. The wavelength division multiplexer according to claim 6, wherein the reflective device is a mirror.

10. A wavelength dividing method comprising the steps of:
receiving multi-wavelength optical signals including a first-wavelength optical signal and a second-wavelength optical signal;
collimating the multi-wavelength optical signals with a collimating device;
transmitting the first-wavelength optical signal to a reflective device through a filter, and reflecting the second-wavelength optical signal to the collimating device from the filter, the collimating device collimating the second-wavelength optical signal toward a second optical output end; and
reflecting the first-wavelength optical signal to the collimator with the reflective device, and collimating the first-wavelength optical signal toward a first optical output end with the collimating device.

11. The wavelength dividing method according to claim 10, wherein the reflective device is a mirror.

12. The wavelength dividing method according to claim 10, wherein the collimating device is a lens or a collimator.

13. The wavelength dividing method according to claim 10, wherein the filter is a narrow band filter.

14. The wavelength dividing method according to claim 10, further comprising the step of:
inclining the filter to a predetermined angle so as to focus the second-wavelength optical signal onto the second optical output end.

15. The wavelength dividing method according to claim 10, further comprising the step of:
inclining the reflective device to a predetermined angle so as to completely reflect the second-wavelength optical signal to the first optical output end.
